(19) United States
(12) Patent Application Publication
(10) Pub. No.: US 2026/0021402 A1
(43) Pub. Date: Jan. 22, 2026

(54) Systems and Methods for Enabling Controlled Character Motion Synthesis in Online Multi-Player Video Games

(71) Applicant: Activision Publishing, Inc., Santa Monica, CA (US)

(72) Inventor: Alexander Bereznyak, Georgetown, TX (US)

(21) Appl. No.: 18/927,297

(22) Filed: Oct. 25, 2024

Related U.S. Application Data
(60) Provisional application No. 63/673,256, filed on Jul. 19, 2024.

(51) Int. Cl. A63F 13/57; G06T 13/40

(52) U.S. Cl. CPC A63F 13/57; G06T 13/40

(57) ABSTRACT

Systems and methods for constructing an offline graph structure configured to enable controlled character motion synthesis in a multi-player online game include a graph structure that has a plurality of master nodes and edges such that each master node is representative of a set of similar dominant poses and edges are representative of plausible transitions between these dominant poses. Motion is generated at runtime by navigating through the graph structure and applying dominant poses from the plurality of master nodes. Since an online game describes a desired motion of a character using a plurality of control parameters therefore, transitions that match the plurality of control parameters most closely are selected from the graph structure.

### CROSS-REFERENCE

The present specification relies on U.S. Patent Provisional Application No. 63/673,256, titled “Systems and Methods for Enabling Controlled Character Motion Synthesis in Online Multi-Player Video Games”, and filed on Jul. 19, 2024, for priority. The above-mentioned application is herein incorporated by reference in its entirety.

### FIELD

The present specification is related generally to the field of character animation or digital human animation. More specifically, the present specification is related to systems and methods for using a graph structure to generate a sequence of motions for runtime or offline usage for realistic character animation or digital human animation.

### BACKGROUND

Realistic human motion is a desirable feature in video games to enable stunning graphics and impactful special effects. Lifelike characters provide an immersive environment for players. However, realistic animation of human motion is challenging as players and spectators are adept at identifying subtleties of human movement and therefore inaccuracies in human animation.

There are various popular methods for animating interactively controlled player characters or game objects in video games. For example, interactive control of animated characters or game objects may be accomplished by relying on transitioning between predefined animations (often clips of motion capture) based on user input. For example, the character may transition from walking to a running animation, and then jump over an obstacle while running. To define transitions between animations, a common approach is the use of state graphs, also called animation state machines (ASM), defining actions as states and connections between states representing transition times.

However, the use of ASM has several disadvantages. First, the realism of motion suffers since an animator may only be able to conceive of a limited number of clips (X) while achieving realism requires a far greater number, for example, on the order of X². Second, ASM does not scale well since any new interaction requires a number of entry and exit points to connect with the data, the creation of which scales geometrically. Third, ASM motion will continuously achieve the same poses from the core library, introducing a tiling effect over time that is similar to texture tiling over space. Fourth, ASM usually has to rely on blend spaces, such as vertical blends of a character's upper and lower body, and procedural add-ons, such as leaning, to add versatility beyond what humans can do. Fifth, since reactivity is based on human-driven clip duration, animators must either opt into sudden ugly blends or manually tag blend windows. Sixth, ASM has no built-in context or history and yet is still very data hungry (meaning that it requires large amounts of input data).

Motion graphs are constructed by pre-calculating transitions between animation segments within a large set of animation data typically obtained from motion capture. Each node of the motion graph represents a sequence of animation, with the graph edges representing transitions. At runtime, the animation segment represented by the current node is played to completion, at which point a transition is taken to a new node that satisfies the desired animation goals. The motion produced is typically high quality, as a result of the flexibility of being able to choose from multiple possible motion paths using the graph structure. One disadvantage is that the use of animation clips tends to make motion graphs less responsive to changing animation goals, which is often the case for interactively controlled player characters in video games.

Motion matching solves this problem by continuously searching the entire animation dataset for a next frame that best fits the current desired animation goals. Quality may be balanced against responsiveness by adjusting the cost function used to identify the best next frame match. The downside of this approach is that it can be hard to predict and control which animation data will be selected at any given time. Newly introduced or modified animation data intended to improve one area of motion may also negatively affect others, which can lead to a reluctance to make changes as the animation database grows. Solving these issues usually involves adding further complexity, such as restricting motion matching to subsets of the animation database at different times.

Current approaches lack the requisite fidelity to produce realistic characters moving in tight spaces, characters interacting with obstacles, and other types of characters. These approaches are best for solving for singular constraints (such as achieving target transform in space-time) and are not agile enough to achieve multiple constraints (for example multi-tasking such as walking around an obstacle while moving to a specific rhythm and face-palming every 3^{rd} step).

Accordingly, there is a need for improved systems and methods for pre-processing motion capture data to generate a graph structure which can be leveraged at runtime to find the best possible motion to synthesize for any set of animation goals.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a computer-implemented method of generating a graph structure configured to enable a synthesis of character motion in a multi-player online video game, the method comprising: receiving motion capture data; identifying a plurality of dominant poses from motion capture data; comparing each dominant pose of the plurality of dominant poses against each remaining ones of the plurality of dominant poses; grouping the dominant poses to form one or more master pose nodes, wherein the dominant poses in each of the one or more master pose nodes are indicative of similar motion over a time window; and adding a plurality of transitions based on successive dominant poses present in each master pose node, wherein each of the plurality of transitions represents pairs of dominant poses that are sufficiently similar for selection in an animation sequence.

Optionally, said identifying the plurality of dominant poses is achieved by sampling the motion capture data to determine poses associated with different positions along a force curve wherein those poses corresponding to maximum and minimum values of the force curve are identified as said dominant poses.

Optionally, the comparison is based on a similarity metric calculated over a fixed time window centered at each dominant pose. Optionally, the similarity metric is a comparison cost value.

Optionally, each of the plurality of transitions comprises a Root transform offset and a duration.

Optionally, the motion capture data can be derived from the plurality of dominant poses by extrapolating a force curve across the plurality of dominant poses.

Optionally, the computer-implemented method further comprises generating motion in the multi-player online video game at runtime by applying one or more of the plurality of dominant poses from the one or more master nodes and by applying one or more of the plurality of transitions that match a plurality of control parameters, wherein the plurality of control parameters define a desired motion of a character in the multi-player online video game.

Optionally, the method further comprises storing data for each of the one or more master pose nodes, wherein the data comprises at least one of dominant poses, weights associated with each of the dominant poses, poses preceding said each of the one or more master pose nodes, a cost of blending said preceding poses, poses succeeding each of the one or more master pose nodes, costs of blending said succeeding poses, and one or more metadata.

The present specification also discloses a system of generating a graph structure configured to enable a synthesis of character motion in a multi-player online video game, the system comprising: at least one game server in communication with a plurality of player client devices, wherein the at least one game server has a non-volatile memory for storing a plurality of programmatic code which, when executed, cause a processor to: receive motion capture data; identify a plurality of dominant poses from the motion capture data; compare each dominant pose of the plurality of dominant poses against each remaining ones of the plurality of dominant poses; group the dominant poses to form one or more master pose nodes, wherein the dominant poses in each of the one or more master pose nodes are indicative of similar motion over a time window; and add a plurality of transitions based on successive dominant poses present in each master pose node, wherein each of the plurality of transitions represents pairs of dominant poses that are sufficiently similar for selection in an animation sequence.

Optionally, said identifying the plurality of dominant poses is achieved by sampling the motion capture data to determine poses associated with different positions along a force curve wherein those poses corresponding to maximum and minimum values of the force curve are identified as said dominant poses.

Optionally, the comparison is based on a similarity metric calculated over a fixed time window centered at each dominant pose.

Optionally, the similarity metric is a comparison cost value. Optionally, each of the plurality of transitions comprises Root transform offset and a duration.

Optionally, the motion capture data can be derived from the plurality of dominant poses by extrapolating a force curve across the plurality of dominant poses.

Optionally, the plurality of programmatic code, when executed, further causes the processor to generate motion in the multi-layer online video game at runtime by applying one or more of the plurality of dominant poses from the one or more master nodes and by applying one or more of the plurality of transitions that match a plurality of control parameters, wherein the plurality of control parameters define a desired motion of a character in the multi-player online video game.

Optionally, the plurality of programmatic code, when executed, further causes the processor to store data for each of the one or more master pose nodes, wherein the data comprises at least one of dominant poses, weights associated with each of the dominant poses, poses preceding said each of the one or more master pose nodes, a cost of blending said preceding poses, poses succeeding each of the one or more master pose nodes, costs of blending said succeeding poses, and one or more metadata.

The present specification also discloses a method of generating a graph structure, comprising: receiving motion capture data; identifying a plurality of dominant poses from the motion capture data; comparing each dominant pose of the plurality of dominant poses against each remaining ones of the plurality of dominant poses, wherein the comparison is based on a similarity metric calculated over a fixed time window centered at each dominant pose; grouping the dominant poses to form one or more master pose nodes, wherein the grouped dominant poses have transition cost values below a predefined threshold; and adding a plurality of transitions based on successive dominant poses present in each master pose node, wherein each of the plurality of transitions represents pairs of dominant poses that are sufficiently similar for selection in an animation sequence.

Optionally, said identifying the plurality of dominant poses is achieved by sampling the motion capture data to determine poses associated with different positions along a force curve wherein those poses corresponding to maximum and minimum values of the force curve are identified as said dominant poses.

Optionally, each of the plurality of transitions comprises Root transform offset and a duration.

Optionally, the motion capture data can be derived from the plurality of dominant poses by extrapolating a force curve across the plurality of dominant poses.

Optionally, the method further comprises generating motion in the multi-player online video game at runtime by applying one or more of the plurality of dominant poses from the one or more master nodes and by applying one or more of the plurality of transitions that match a plurality of control parameters, wherein the plurality of control parameters define a desired motion of a character in the multi-player online video game.

Optionally, the method further comprises storing data for each of the one or more master pose nodes, wherein the data comprises at least one of dominant poses, weights associated with each of the dominant poses, poses preceding said each of the one or more master pose nodes, a cost of blending said preceding poses, poses succeeding each of the one or more master pose nodes, costs of blending said succeeding poses, and one or more metadata.

The present specification also discloses a computer-implemented method of generating a graph structure configured to enable controlled character motion synthesis in a multi-player online gaming system, the method comprising: identifying, from a corpus of motion capture data, a subset of artistically relevant dominant poses; comparing each of the identified subset of dominant poses against the remaining subset of dominant poses; grouping the dominant poses, indicative of similar motion over a time window, to form one or more master pose nodes; and adding a plurality of transitions based on successive dominant poses present in each master pose node.

Optionally, the motion capture data is sampled using a measurement of force invested, wherein poses corresponding to values of peaks and valleys of a force curve are identified as dominant poses.

Optionally, the comparison is based on a similarity metric calculated over a fixed time window centered at each dominant pose.

Optionally, each of the plurality of transitions includes Root transform offset and a duration.

Optionally, the dominant poses are indicative of a minimal set which can be used to rebuild the whole motion capture data.

Optionally, the method of claim further comprises generating motion at runtime by applying one or more dominant poses from the one or more master nodes and by applying one or more transitions that match a plurality of control parameters, wherein the plurality of control parameters describe a desired motion of a character in a multi-player online game.

Optionally, for each of the one or more master pose nodes, at least following data is stored: a list of dominant poses affected, including weights; a list of incoming master poses (predecessors on a timeline) with costs of blending; a list of outgoing master poses (successors on the timeline) with costs of blending; or one or more metadata to serve as tags.

The present specification also discloses a system for generating a graph structure configured to enable controlled character motion synthesis in a multi-player online game, the system comprising: at least one game server in communication with a plurality of player client devices, wherein the at least one game server has a non-volatile memory for storing a plurality of programmatic code which, when executed, cause a processor to: identify, from a corpus of motion capture data, a subset of artistically relevant dominant poses; compare each of the identified subset of dominant poses against the remaining subset of dominant poses; group the dominant poses, indicative of similar motion over a time window, to form one or more master pose nodes; and add a plurality of transitions based on successive dominant poses present in each master pose node.

Optionally, the motion capture data is sampled using a measurement of force invested, wherein poses corresponding to values of peaks and valleys of a force curve are identified as dominant poses.

Optionally, the comparison is based on a similarity metric calculated over a fixed time window centered at each dominant pose.

Optionally, each of the plurality of transitions includes Root transform offset and a duration.

Optionally, the dominant poses are indicative of a minimal set which can be used to rebuild the whole motion capture data.

Optionally, the plurality of programmatic code which, when executed, further causes the processor to generate motion at runtime by applying one or more dominant poses from the one or more master nodes and by applying one or more transitions that match a plurality of control parameters, wherein the plurality of control parameters describe a desired motion of a character in the multi-player online game.

Optionally, for each of the one or more master pose nodes, at least following data is stored: a list of dominant poses affected, including weights; a list of incoming master poses (predecessors on a timeline) with costs of blending; a list of outgoing master poses (successors on the timeline) with costs of blending; or one or more metadata to serve as tags.

The present specification also discloses a method of generating a graph structure, comprising: identifying, from a corpus of motion capture data, a subset of artistically relevant dominant poses; comparing each of the identified subset of dominant poses against the remaining subset of dominant poses, wherein the comparison is based on a similarity metric calculated over a fixed time window centered at each dominant pose; grouping the dominant poses, having transition cost values below a predefined threshold, to form one or more master pose nodes; and adding a plurality of transitions based on successive dominant poses present in each master pose node.

Optionally, the motion capture data is sampled using a measurement of force invested, wherein poses corresponding to values of peaks and valleys of a force curve are identified as dominant poses.

Optionally, each of the plurality of transitions includes Root transform offset and a duration.

Optionally, the dominant poses are indicative of a minimal set which can be used to rebuild the whole motion capture data.

Optionally, the method further comprises generating motion at runtime by applying one or more dominant poses from the one or more master nodes and by applying one or more transitions that match a plurality of control parameters, wherein the plurality of control parameters describe a desired motion of a character in a multi-player online game.

Optionally, for each of the one or more master pose nodes, at least following data is stored: a list of dominant poses affected, including weights; a list of incoming master poses (predecessors on a timeline) with costs of blending; a list of outgoing master poses (successors on the timeline) with costs of blending; or one or more metadata to serve as tags.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates an embodiment of a multi-player online gaming or massively multiplayer online gaming system in which the systems and methods of generating a graph structure may be implemented or executed, in accordance with some embodiments of the present specification;

FIG. 2 illustrates a force curve calculated from sampling mocap data points, in accordance with some embodiments of the present specification;

FIG. 3 illustrates first and second sets of dominant poses, frames or PDPs identified for walk forward and back, in accordance with some embodiments of the present specification;

FIG. 4A illustrates a set of dominant poses conceptually represented as a pyramid, in accordance with some embodiments of the present specification;

FIG. 4B illustrates another representation of the pyramid of FIG. 4A based on color-coding a convergence level, in accordance with some embodiments of the present specification;

FIG. 4C illustrates a generalized graph space using dominant poses, frames or PDPs of the convergence level, in accordance with some embodiments of the present specification;

FIG. 4D illustrates a plurality of graph paths generated by leveraging the generalized graph space of FIG. 4C, in accordance with some embodiments of the present specification;

FIG. 5A illustrates a plurality of dominant poses, frames or PDPs identified from exemplary mocap data, in accordance with some embodiments of the present specification;

FIG. 5B illustrates closely matching dominant poses for an exemplary dominant pose, in accordance with some embodiments of the present specification;

FIG. 5C illustrates direct and natural successors of the closely matching dominant poses of FIG. 5B, in accordance with some embodiments of the present specification;

FIG. 5D illustrates a field 508 of possible pasts and futures, in accordance with some embodiments of the present specification;

FIG. 5E illustrates how all dominant poses carry effect on the source mocap data, in accordance with some embodiments of the present specification;

FIG. 5F illustrates the uniqueness of each dominant pose over the source mocap data, in accordance with some embodiments of the present specification;

FIG. 6A illustrates visualization of effect of two master poses over timeline, in accordance with some embodiments of the present specification;

FIG. 6B illustrates visualization of effect of six master poses over timeline, in accordance with some embodiments of the present specification;

FIG. 7A is a flowchart of a plurality of exemplary steps of a method of identifying dominant poses, frames or PDPs, in accordance with some embodiments of the present specification;

FIG. 7B is a flowchart of a plurality of exemplary steps of a method of comparing the identified dominant poses, frames of PDPs, in accordance with some embodiments of the present specification;

FIG. 7C is a flowchart of a plurality of exemplary steps of a method of grouping the identified dominant poses, frames of PDPs to form one or more master poses, in accordance with some embodiments of the present specification; and

FIG. 7D is a flowchart of a plurality of exemplary steps of a method of generating a graph structure configured to enable controlled character motion synthesis, in accordance with some embodiments of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The term “a multi-player online gaming” or “massively multiplayer online gaming” environment may be construed to mean a specific hardware architecture in which one or more servers electronically communicate with, and concurrently support game interactions with, a plurality of client devices, thereby enabling each of the client devices to simultaneously play in the same instance of the same game. Preferably the plurality of client devices number in the dozens, preferably hundreds, preferably thousands. In one embodiment, the number of concurrently supported client devices ranges from 10 to 5,000,000 and every whole number increment or range therein. Accordingly, a multi-player gaming environment or massively multi-player online game is a computer-related technology, a non-generic technological environment, and should not be abstractly considered a generic method of organizing human activity divorced from its specific technology environment.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module” or “engine” used in this disclosure may refer to computer logic utilized to provide a desired functionality, service or operation by programming or controlling a general-purpose processor. Stated differently, in some embodiments, a module, application or engine implements a plurality of instructions or programmatic code to cause a general-purpose processor to perform one or more functions. In various embodiments, a module, application or engine can be implemented in hardware, firmware, software or any combination thereof. The module, application or engine may be interchangeably used with unit, logic, logical block, component, or circuit, for example. The module, application or engine may be the minimum unit, or part thereof, which performs one or more particular functions.

The term “runtime” used in this disclosure refers to one or more programmatic instructions or code that may be implemented or executed during gameplay (that is, while one or more game servers are rendering a game for playing).

The term “force invested or spent” as used in this disclosure refers to energy investment required to achieve any pose that has offset from a previous one in a dynamic sequence. Such energy investment comes from outside forces such as gravity, inertia, normal/frictional/tension forces, air resistance, buoyancy, and physical forces resulting from muscles exerting pull or push, and other such movements.

The term “Root” used in this disclosure refers to the highest joint/bone in a hierarchy of a virtual character skeleton. Root is often used as an approximation of character location and orientation to run calculations such as, for example, replacing a character with a capsule to check if the width allows passing around obstacles.

The terms “master pose”, “dominant pose” and “principal dynamic pose (also referred to as “PDP”)” are used interchangeably throughout this disclosure.

The terms “master node”, “master pose node” and “master pose group” are used interchangeably throughout this disclosure.

The term “graph structure” used in this disclosure refers to a data structure, stored in a non-transient computer memory, that is a hybrid between state machines and motion matching, that utilizes high-dimensional data processing for creating dynamic, realistic, and responsive animated character behaviors.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a” “an” and “the” include plural references unless the context dictates otherwise. Although any systems and methods similar or equivalent to those described herein can be used in the practice or testing of embodiments of the present disclosure, the preferred, systems and methods are now described.

### Overview

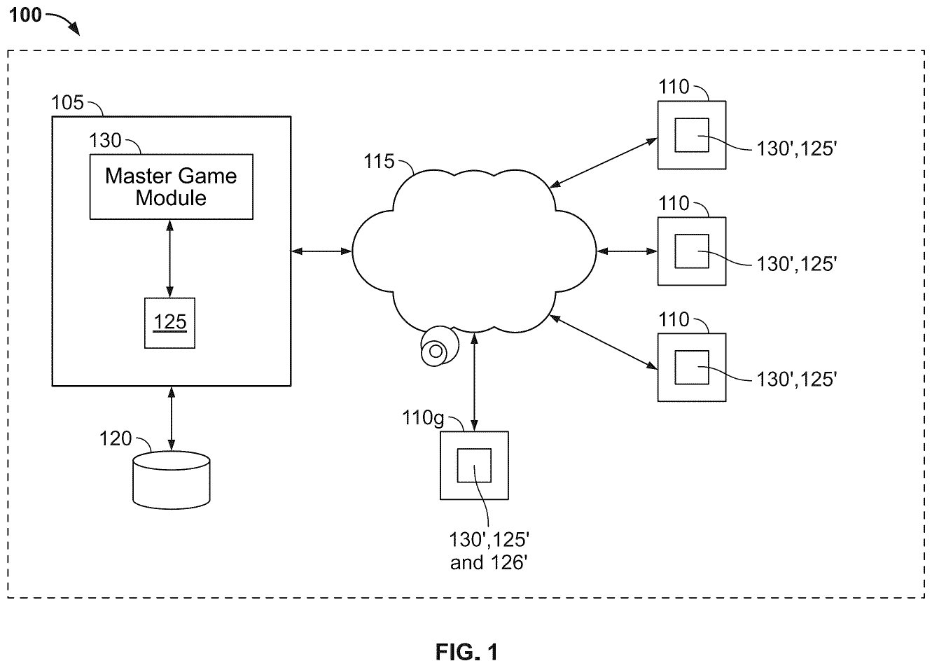

FIG. 1 illustrates an embodiment of a multi-player online gaming or massively multiplayer online gaming system/environment 100 in which the systems and methods of generating a graph structure (configured to enable controlled character motion synthesis) may be implemented or executed, in accordance with some embodiments of the present specification. The system 100 comprises client-server architecture, where one or more game servers 105 are in communication with one or more client devices 110 over a network 115. Players and non-players, such as computer graphics and animation personnel, may access the system 100 via the one or more client devices 110. The client devices 110 comprise computing devices such as, but not limited to, personal or desktop computers, laptops, Netbooks, handheld devices such as smartphones, tablets, and PDAs, gaming consoles and/or any other computing platform known to persons of ordinary skill in the art. Although three client devices 110 are illustrated in FIG. 1, any number of client devices 110 can be in communication with the one or more game servers 105 over the network 115.

In some embodiments, the one or more game servers 105 may be implemented by a cloud of computing platforms operating together as game servers 105.

The one or more game servers 105 can be any computing device having one or more processors and one or more computer-readable storage media such as RAM, hard disk or any other optical or magnetic media. The one or more game servers 105 include a plurality of modules operating to provide or implement a plurality of functional, operational or service-oriented methods of the present specification. In some embodiments, the one or more game servers 105 include or are in communication with at least one database system 120.

In some embodiments, the database system 120 stores a plurality of game data including a corpus of motion capture (“mocap”) data (associated with at least one game that is served or provided to the client devices 110 over the network 115) indicative of a plurality of animation clips where each of the plurality of animation clips is representative of a sequence of poses over time and includes a plurality of frames. Alternatively, or additionally, the database system 120 may include hand-authored or procedurally generated data containing fluid realistic motion. Thus, while the term “mocap data” is used hereinafter to describe various systems and methods of the present specification, it should not be construed as limiting since the systems and methods of the present specification are equally applicable to human-generated animations.

In various embodiments, each principal dynamic pose (PDP) of the mocap data has, associated therewith, pre-calculated metadata such as, but not limited to, a) velocity data indicative of an average displacement of body parts over a past frame using point cloud, b) acceleration data, c) force invested or spent (average force acting on each unit of body; actual location compared to predicted one based on previous location, velocity, gravity), d) location and orientation of center of mass (COM) of a body pose, c) location and orientation of Root, f) any tags for events (single frame) or states (duration), including “deprecated” tags which exclude portions of data from calculation, and any tags game logic may query, g) current transforms and velocities, h) index of PDP, i) address of PDP—that is, file and frame, j) list of similarity costs to all other PDPs, k) reference/pointer to closest similar PDP with respective cost, l) original predecessor and successor PDP, m) number of possible predecessors and successors in current data with cost <=1.0, as well as offsets to each in space and time, n) any user defined tag (such as, for example, “sneeze”, etc.), o) any information related to collision object transform relative to Root, p) any information related to body parts colliding, and q) any information on context outside that derived from anatomical pose, such as, but not limited to amplitude of speech. It should be noted that the listing of pre-calculated metadata is provided by way of example only and not meant to be exhaustive. Other metadata may be included in the list so as to achieve the objectives of the present specification.

In accordance with aspects of the present specification, the one or more game servers 105 provide or implement a plurality of modules or engines such as, but not limited to, a motion synthesis module 125 and a master game module 130. In some embodiments, the one or more client devices 110 are configured to implement or execute one or more client-side modules at least some of which are same as or similar to the modules of the one or more game servers 105. For example, in some embodiments each of the player client devices 110 executes a client-side game module 130′ that integrates a client-side motion synthesis module 125′.

In some embodiments, the client-side motion synthesis module 125′ is configured to use a predetermined or pre-generated graph structure, also available at the game server 105, on each of the client devices 110, by replicating the internal state and any control parameters (such as, for example, actions of other players, artificial intelligence (this refers to non-player characters that are controlled by “artificial intelligence” game code on the game server 105), context and/or or any server initiated non-deterministic event which comes with any degree of randomness in its timing or effect, such as, but not limited to a lightning strike, for example) that cannot be reconstructed from other data. In some embodiments, the internal state is sufficient to reconstruct an animation pose or frame and run updates for client-side prediction. In embodiments, the client-side motion synthesis module 125′ is configured to synchronize its location (i.e., previous/next nodes) within the graph structure with the game server 105 and collect sufficient contextual information in the form of state and/or control parameters to allow prediction of subsequent transitions.

In various embodiments, the server-side motion synthesis module 125 and the client-side motion synthesis module 125′ together function as a high-level control system that modifies an animation blend tree and requires its state to be replicated across the network 115 to maintain client/server synchronization. A graph structure update will operate on a current state of a generated graph structure, elapsed time and a set of control parameters and produce an updated graph structure state as its output. A primary input to the update will be the set of control parameters from game code each frame that describe the intended motion. These parameters are synchronized (by the server-side motion synthesis module 125 and the client-side motion synthesis module 125′) between client and server to ensure that the graph structure update is as close to deterministic as possible. Example control parameters include: a) desired/predicted character trajectory in terms of root bone transformations at key times in the future, b) other desired bone transforms, for example: torso direction (required to support strafing where character faces one direction and moves in another), c) metadata describing motion, such as stance (prone, crouched, standing), mantling, jumping, hiding behind cover (metadata may be associated with specific times in the future) and d) scalar quantities to be matched, for example height of wall when mantling. Historical data such as the past trajectory may also be included as control parameters.

In some embodiments, the graph structure update process takes the form of a search through the graph structure, starting from the current state, in order to find the lowest cost path that satisfies the constraints represented by the control parameters. Given the expected high connectivity of the graph structure, the search is optimized by skipping transitions that exceed a lowest cost found so far. The search involves building multiple future trajectories based on a root motion encoded in each graph structure transition and comparing these to the desired trajectory provided by the master game module 130 (i.e., the game code). In various embodiments, the depth of the search depends on how far in the future the desired trajectory extends and the root movement speeds present in the graph structure animation data. In embodiments, the search also incorporates calculation of costs for the control parameters (including, desired bone transforms, metadata, scalar quantities, and other such metrics). In some embodiments, the trajectory cost and the costs calculated for each control parameter are combined using a weighted sum to yield a single overall cost value.

Graph structure animation data might include animation segments or PDPs (those segments or poses that have some amount of velocity or movement). This is only a subset of the full motion capture or handmade sequences. At the same time, in some embodiments, the complete incoming sequences may be stored in the engine and reduce the content on demand on build.

In some embodiments, at least one non-player client device 110g executes the client-side game module 130′ that integrates a client-side motion synthesis module 125′ and a graph structure game development tool (GDT) module 126′. In various embodiments, the GDT module 126′ is configured to generate one or more graphical user interfaces (GUIs) to enable the computer graphics and animation personnel to program at least the server-side motion synthesis module 125 and the client-side motion synthesis module 125′ (collectively referred to, hereinafter, as the “motion synthesis module 125”).

### Motion Synthesis Module 125

In various embodiments, the motion synthesis module 125 implements a plurality of instructions of programmatic code to generate or construct an offline graph structure (also referred to as ‘hyperpose graph’ or ‘hyperpose’) having a plurality of master nodes and edges, such that each node is representative of a set of similar dominant poses (instead of animation clips) and edges are representative of plausible transitions between all dominant poses (although, a vast majority of such edges are deprecated due to quality and footprint/search considerations). It should be appreciated that combining similar poses into a single node helps reduce complexity of the graph structure by taking advantage of redundancy present in the source mocap data. It should further be appreciated that such an offline graph structure comprises a data structure stored in a non-transient computer memory.

In embodiments, the motion synthesis module 125 is further configured to generate motion at runtime by navigating through the graph structure and applying dominant poses from the plurality of master nodes of the graph structure. Since, a video game describes a desired motion using a plurality of control parameters (such as, for example, predicted root trajectory), therefore, transitions that match the plurality of control parameters most closely are selected (from the graph structure). In embodiments, the motion synthesis module 125 is configured to search ahead in the graph structure to synthesize motion paths that may not exist in the source mocap data. It should be understood that “searching ahead” is in the context of taking a current state and reading a list of possible “child” or “target” PDPs. This list can then be analyzed and rated based on feasibility of each node in regard to achievement of a desired goal (such as, for example, “getting closer to a target PDP”, “leading to a desired tag”, or any other such goal).

### Frame of Reference (Root)

It should be appreciated that the systems and methods of the present specification are based on the concept of a graph structure that is directed towards increasing the dimensionality of source mocap data or content and saturating the result with ‘N’ samples. Stated differently, any source mocap data is represented as one 4D (four dimensional) object, also referred to as a graph structure, which is a pose with an extra dimension of ‘time’. Thus, the graph structure can be illustrated as all possible states (poses) over-imposed on top of each other. This representation would be a 3D projection of a 4D object. Such a graph structure can be subsequently compressed as a set of samples describing the whole source mocap data, and the source motion can be reconstructed based on the samples and their native connections in the source mocap data. Consequently, any adjustment, modulation or updates to such samples invariably propagates into the adjustment of the whole mocap data, allowing adaptation, stylization, secondary asset stylization, and the like.

The samples have natural “predecessors” and “successors.” Some samples occupy the same space and thus are considered similar, sharing connections to form a network, resulting in a graph structure that can be navigated based on conditions. Such conditions are represented by the intersection of two sets or lists: a) a first list of requirements that the game design or AI (artificial intelligence) may request to be fulfilled (distance traveled, speed, orientation, specific data tag, or any other request) and b) a second list of requirements stored per PDP. Persons of ordinary skill in the art would appreciate that if light is shined on a 3D object, different 2D projections (shadows) are produced based on the angle at which the light is shined. Similarly, in the case of graph structure mechanics, by shining a light on a 4D object from different coordinate frames, different 3D shadows are generated. While all shadows are contained in a higher dimension object, only one is actualized at a time.

It should be appreciated that the collapse of 3D poses over time into one 4D pose is only meaningful if a deterministic Root is generated per item. There are several approaches known to persons of ordinary skill in the art such as, for example, joints, topology, collision primitive set, and voxelization (point cloud). While joints and topology seem to be readily available, their distribution is predicated on local desired fidelity and curvature and thus favors body parts based on parameters irrelevant to the comparison (i.e., fingers end up having more items than forearms).

Objects, such as, for example, player-controlled characters, in a video game scene are typically modeled as three-dimensional meshes comprising geometric primitives such as, for example, triangles or other polygons whose coordinate points are connected by edges. In some embodiments, the motion synthesis module 125 implements a plurality of instructions of programmatic code to generate a tetrahedral lattice (THL) point cloud in the volume of character mesh, skin to core joints by using skin wrap of the character mesh for ultra-fidelity pass, and use sparse joints and a proxy volume mesh for quick passes. Stated differently, in some embodiments, the motion synthesis module 125 uses voxelization with tetrahedral point distribution instead of a square point distribution. However, alternate embodiments may use a square point distribution. In accordance with some embodiments, an optimum convergence of number of points versus quality of representation is achieved around 10 points per liter or 660 per average human body.

In some embodiments, the motion synthesis module 125 implements a plurality of instructions of programmatic code to further determine a plurality of THL measurements including THL locations, their inertia, and velocity. Based on the plurality of THL measurements a center of mass (COM), for a pose, is determined. Projection of a COM, downwards on the floor, is referred to as Root. Thus, all poses achieved in the source mocap data can be combined using THL defined Root as a frame of reference. For any pose the character achieves, similar poses get similar transforms. Having Root as the frame of reference enables snapping of the poses together by their best mathematically possible transform, which is not dependent on data size—that is, consistent and deterministic. Thus, if all transforms pertaining to each pose are given in space of Root, any two poses are compared in the shared space.

### Graph Structure Construction

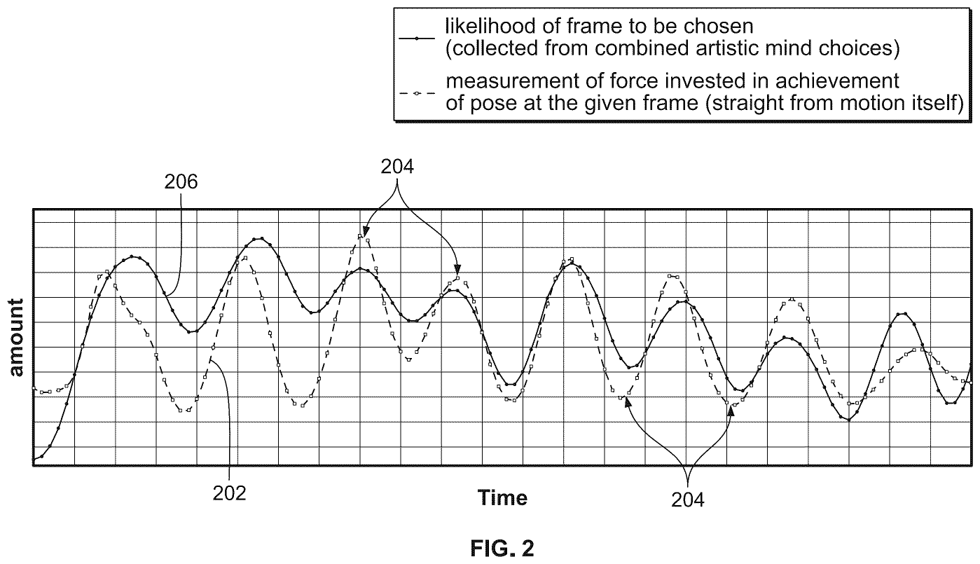

Identifying dominant poses or frames: In embodiments, generation of the graph structure begins by automatically identifying or determining, from the corpus of source mocap data, a subset of dominant poses or frames (also referred to as ‘principal dynamic poses’ (PDPs)) that are intended to be artistically relevant or important (that is, poses or frames similar to those artists would choose). The set of dominant poses or frames are indicative of a minimal set which can be used to rebuild the whole source mocap data. To identify dominant poses or frames, the motion synthesis module 125 is configured to implement a method of motion segmentation that can be applied to whole motion sequences to identify the most artistic “cut” frames. The plurality of THL measurements enable determining velocity, acceleration and force invested or spent or work done at any given point in the mocap data. In some embodiments, the method of motion segmentation samples mocap data using the measurement of force invested or spent (i.e., work done). FIG. 2 shows a force curve 202 calculated from sampling mocap data points, in accordance with some embodiments of the present specification. The force curve 202 is indicative of a measurement of force invested in achievement of a pose at a given frame. A second curve 206 is indicative of a likelihood of frames to be chosen, as collected from combined artistic mind choices.

In some embodiments, the method of motion segmentation identifies poses or frames corresponding to the peaks and valleys values 204 (or the maximum and minimum values), of the force or work done curve 202, as special states, referred to as dominant poses, frames or PDPs. Effectively, the motion synthesis module 125 is configured to calculate data indicative of velocity, acceleration and energy invested in movement per frame. The calculated data, when plotted or otherwise analyzed, form a curve over time that resembles a phase function or sine wave. The curve is smoothed and frames corresponding to the peaks and valleys of the curve are referred to as the dominant poses, frames or PDPs. Thus, the method of motion segmentation identifies dominant poses, frames or PDPs that bear very close resemblance to the poses or frames picked by artists. For example, on average, it was found that various artists deviated +/−3 frames from each other when they selected the best poses or frames from a timeline, whereas the method of motion segmentation provides an average +/−1.25 frame deviation from average human choice.

It should be appreciated that once a set of dominant poses, frames or PDPs have been identified, for a motion sequence, all in-between poses or frames may be considered as derivatives of the set of dominant poses, frames or PDPs and hence can be reconstructed from the dominant set. Stated differently, the whole of the motion sequence is represented with its' small but most influential subset of poses or frames, namely the dominant poses, frames or PDPs. Thus, the source motion capture data can be derived from the set of dominant poses or frames by extrapolating a force curve across the set of dominant poses.

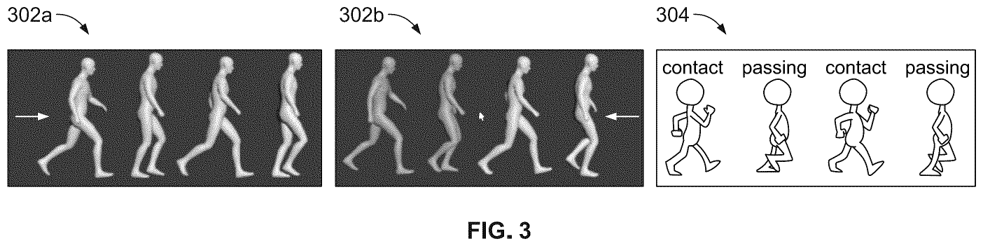

As a non-limiting illustration, FIG. 3 shows a convergence set output of dominant poses, frames or PDPs 302a, 302b identified from a set of walk forward and walk backward, in accordance with some embodiments of the present specification. Effectively, the whole motion can be represented with a first set 302a of four poses for walking forward and a second set 302b of four poses for walking backward. The first and second sets 302a, 302b are identified automatically using the method of motion segmentation of the present specification. The identified first and second sets 302a, 302b map to the classic representation of a walk cycle and replicate pose segmentation or cuts 304 determined by an application of artistic mind to mocap data. The dominant poses, frames or PDPs of the present specification are artistic, deterministic, and character-agnostic.

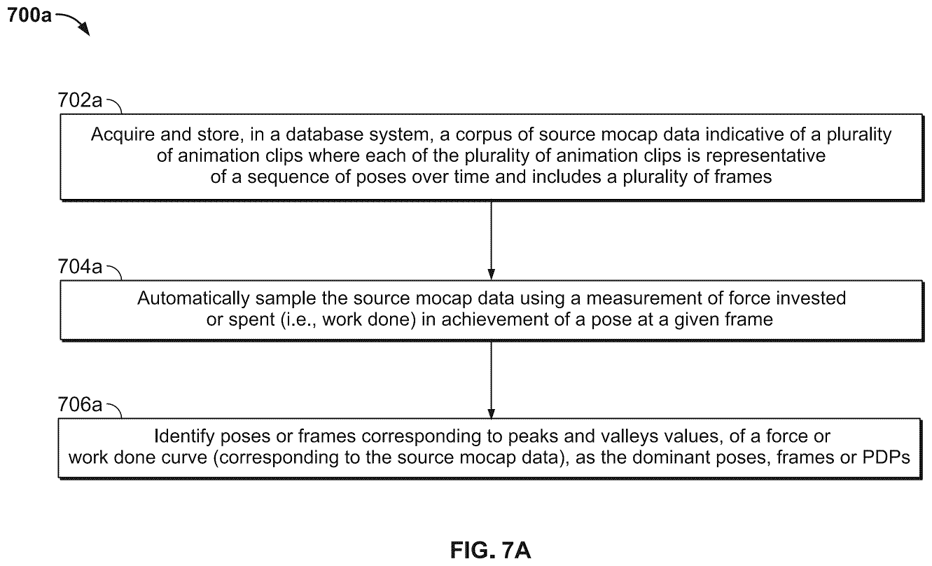

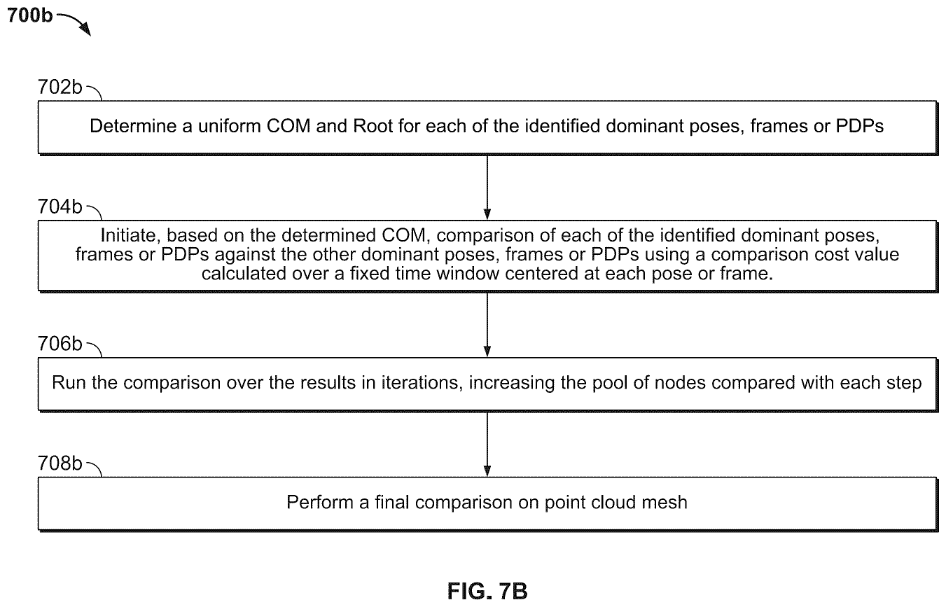

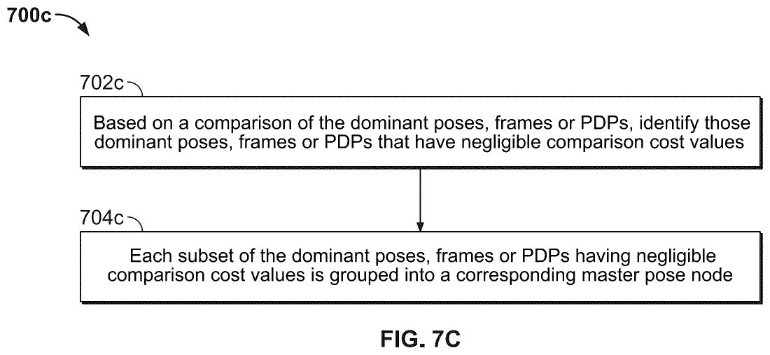

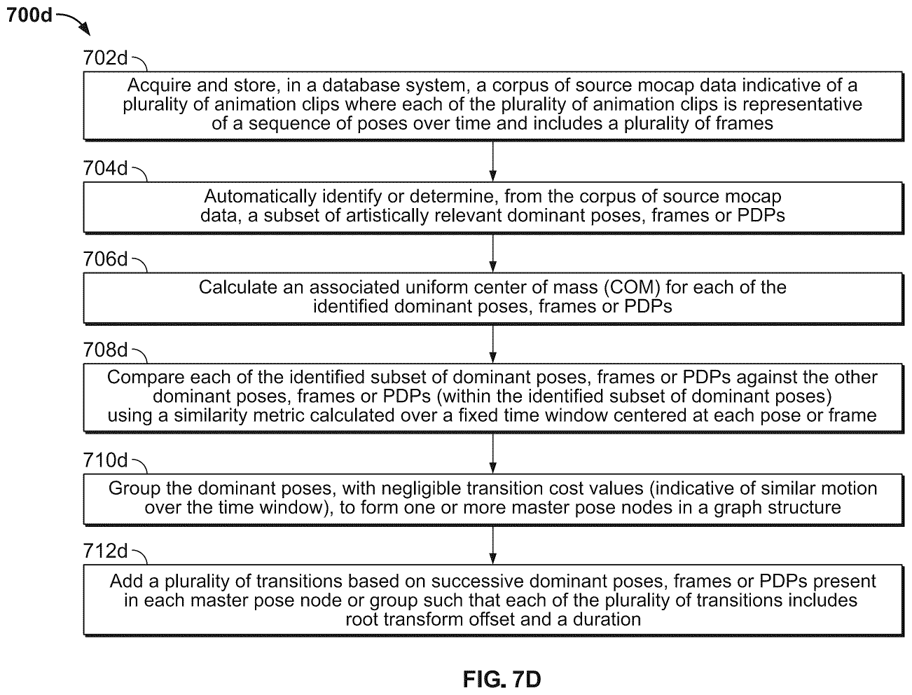

FIG. 7A is a flowchart of a plurality of exemplary steps of a method 700a of identifying dominant poses, frames or PDPs, in accordance with some embodiments of the present specification. In various embodiments, the method 700a is implemented by the motion synthesis module 125.

Referring now to FIGS. 1 and 7A, at step 702a, acquire and store, in the database system 120, a corpus of source mocap data indicative of a plurality of animation clips where each of the plurality of animation clips is representative of a sequence of poses over time and includes a plurality of frames. Alternatively, or additionally, the database system 120 may store hand-authored or procedurally generated data containing fluid realistic motion.

At step 704a, the module 125 automatically samples the source mocap data using a measurement of force invested or spent (i.e., work done) in achievement of a pose at a given frame. In some embodiments, a plurality of THL measurements enable determining velocity, acceleration and force invested or spent or work done at any given point in the source mocap data.

At step 706a, the module 125 identifies poses or frames corresponding to peaks and valleys values, of a force or work done curve (corresponding to the source mocap data), as the dominant poses, frames or PDPs.

Comparing dominant poses or frames: each of the identified subset of dominant poses, frames or PDPs is then compared against each of the other dominant poses, frames or PDPs (that is, each PDP is compared against each other PDP) in the database using a comparison cost value calculated over a fixed time window centered at each pose or frame. The use of a time window is important as it means that pose similarity is not based solely on bone transforms at a particular instant in time, although the motion of the bones before and after the pose or frame is also considered. Thus, dominant pose comparison includes the dynamic part or velocity. In embodiments, dominant pose comparison compares not just two dominant poses but their time-related context as well. Dominant pose comparison is based on a potential of dynamic poses to achieve each other, as in the ability to blend from dominant pose ‘A’ to dominant pose ‘B’.

If a body is represented with its volume, it is possible to identify the true center of mass (COM) for any pose the body achieves. Accordingly, an associated uniform center of mass (COM) and Root is calculated for each of the identified dominant poses, frames or PDPs. For the purpose of pose comparison, Root being consistent and deterministic is desired, since all comparison happens in space of Root. Thus, two identical poses with Roots being offset in either direction would not be considered identical since in space of Root, all joints are offset. Classical placement of Root joint was quite often done by hand and was not deterministic. For large data sets which disallow manual placement, the Root quite often was placed as projection of average ankle location, or projection of the hip joints, which may be inaccurate (consider a karate kick pose placed “between ankles” Root, which would be widely off center of mass, or crouched pose placing “hip projection” Root, which would be way behind the center of mass). The approach of the present specification with pre-calculated COM (center of mass) is desirable for pose comparison and subsequent processing.

Since the number of comparisons to run scales up geometrically, in some embodiments, a staged comparison is performed (of each of the identified dominant poses, frames or PDPs against the other dominant poses, frames or PDPs). In the first pass or stage, a comparison is performed of one single node of each of two candidate poses: COM (center of mass). It is possible for two different poses to have similar COM, but it is not possible for two similar poses to have different COMs. Thus, in the first pass or stage a large number of comparisons are eliminated which would have resulted in poor quality anyway, however, a number of false positives still remain. In the second pass or stage, a comparison is performed of the poses using several nodes (say, for example, joints for ankles, hands, pelvis, shoulders, and head). Similar to COM, some bad connections are eliminated from further calculations. On the third pass or stage, a plurality of joints such as, for example 32 joints, may be considered. On the final pass or stage, a comparison is performed point cloud mesh to point cloud mesh for top fidelity.

Thus, the comparison (of each of the identified dominant poses, frames or PDPs against the other dominant poses, frames or PDPs) is an N\hat{ }2 process, so multiple passes with thresholding is required to manage memory and performance costs. The comparison (of each of the identified dominant poses, frames or PDPs against the other dominant poses, frames or PDPs) is initiated based on the COM, which eliminates the definitively bad connections and shrinks the problem space. For example, a COM of walk backwards has a negative Y-axis velocity, while a COM of walk forward has a positive Y-axis velocity. Thus, there is need to compare all the point cloud, or any extra joints, since there is no condition under which such vast difference can be diminished on a more detailed level.

Thereafter, the comparison is run over the results in iterations, increasing the pool of nodes compared with each step. The final comparison, being the most accurate one, is done on point cloud mesh. The proper multipliers of the interim passes are set such that no valid connections are lost due to interim filters and only the bad connections are skipped to save calculation time. In increasing the number of nodes in the comparison set with each successful pass or stage, a degree of error can be introduced in the early stages to avoid false negatives. These can be used as multipliers to the resulting cost, for example a 0.5 multiplier for COM comparison, 0.75 multiplier for second stage, and so forth. However, an exact multiplier to use (at each pass or stage) is dependent on the specific set of nodes used. Since dominant poses are compared with their immediate predecessors and successors (history and future) in mind, the comparison is performed in four dimensions.

It should be appreciated that to transition between two dynamic poses or PDPs A and B, an offset is introduced, but each motion already has some offset present (temporal, i.e., “motion”). In some embodiments, the offset required for the transition is compared to the offset present in both candidates (A and B) to calculate a comparison cost value. The comparison cost value, in some embodiments, is determined by dividing the distance between some node of pose A and the same node of pose B, by an average velocity of the two poses. Thereafter, an average or median result of all nodes combined is taken. Thus, since each PDP has velocity, it is compared with offsets required to achieve each other PDP (using Roots as a coordinate frame). The comparison cost value is equal to 0 for self-transition (since offset required equals 0) and to 1.0 in the case of motions where just enough temporal offset is present to match the required one. A cost value of 0 means perfect transition, and 1.0 means transition which seems borderline “good” given the motions. Stated differently, the motion synthesis module 125 compares offsets to counteract (distance to cover due to pose difference) and offsets to current velocity (capacity to cover distance), with both as vectors-direction of offset and direction of movement, respectively. Thus, fast moving poses will have an easier time blending (covering distance) to other poses. When the capacity to cover distance is equal to the distance to cover, the cost is 1.0. When the distance to cover is 0 (poses are identical), the cost is 0. The lower the cost, the better. In some embodiments, motion vector differences are also factored, so two completely position-wise matching poses having opposite velocity vectors will not yield a cost of 0 but will factor in the inertia.

In some embodiments, cost values associated with each transition from a dominant pose to every other dominant pose (in the identified subset of artistically relevant dominant poses, frames or PDPs) are calculated and stored in the database system 120. The stored cost values include those ranging from 0 to 1.0 as well as those above 1.0. Cost values over 1.0 are possible and also stored in order to parse them if no good transition is available for other reasons, which allows finding the ‘next best possible’ connection where the ‘best’ is not available.

In embodiments, a maximum comparison cost value can be manipulated or customized to determine a desired number of PDPs. This enables determining optimal PDPs to represent ‘N’ megabytes, and the process does not affect the number of motions but their reconstructed fidelity. This scalability is immensely effective for LODs and allows parity with mobile without dropping any mechanics.

FIG. 7B is a flowchart of a plurality of exemplary steps of a method 700b of comparing the identified dominant poses, frames of PDPs, in accordance with some embodiments of the present specification. In various embodiments, the method 700b is implemented by the motion synthesis module 125, which is configured accordingly.

At step 702b, the module 125 determines a uniform COM and Root for each of the identified dominant poses, frames or PDPs.

At step 704b, the module 125 initiates, based on the determined COM, a comparison of each of the identified dominant poses, frames or PDPs against the other dominant poses, frames or PDPs in the database using a comparison cost value calculated over a fixed time window centered at each pose or frame.

At step 706b, the module 125 runs the comparison over the results in iterations, increasing the pool of nodes compared with each step.

At step 708b, the module 125 performs a final comparison on point cloud mesh.

In embodiments, dominant poses are grouped to form one or more master pose nodes. Based on a comparison of the dominant poses, frames or PDPs, it is observed that many of them have negligible comparison cost values and can therefore be grouped into master pose nodes. That is, the dominant poses can be grouped based on their transition or comparison cost values. In embodiments, it should be noted that cost values may have a wide range, which allows the user to introduce a threshold for grouping similar PDPs into master pose nodes. As a general rule, the higher the threshold, the more poses that are grouped together with a lower extent of similarity, and a smaller number of nodes to work with, and therefore a smaller footprint. A lower threshold allows for more blend quality precision at the cost of working with a larger set of nodes. In allowing for a tunable threshold, the present invention affords greater scalability options while allowing for the same data to be built for both low end and high-end platform specifications.

It should be appreciated that very low-cost values indicate that the poses are effectively identical, and thus, the utility of including them in the final data set is low. In contrast, unique poses have no “under 1.0” similarities; such poses contribute a substantial amount of “character” and uniqueness into the set, and thus might be more useful to keep. There might also be glitches in the data, such as singular flipping of both knees to bend backward. This approach helps identify such outliers and enables awareness to disapprove of or deprecate them.

Dominant poses with similar motion over the time window (as defined by a time threshold that, in some embodiments, is 7 frames in the past, 7 frames in the future, with 30 FPS—that is, analyzing half a second in total. This is implied by average spacing of PDPs by 7.5 frames. In some embodiments, it is possible to use case-specific time thresholds, based on actual time distance to previous and next PDP on case-by-case basis) are grouped together to form a “master pose” node in the graph structure. For example, dominant poses related to walk forward and back animation sequence may be grouped into a corresponding master pose node. Thus, the graph structure encapsulates all PDPs and metadata of each PDP related to its possible predecessor, successor, and similar PDPs.

In embodiments, transitions from each master pose node are determined by the successors of its constituent PDPs. Say there are PDPs A and B and that there are also PDPs X and Y. It may be known that in the source data A leads to B and X leads to Y. It is known that the connection cost of A->B is 0 by querying possible parents of B and checking their costs to A. Since possible parents of B include A itself, such cost is then 0. If there is a case where A is similar to X with a cost of 0.2, this now means A can lead to Y with cost of 0.2, or X can lead to B with the cost of 0.2. Thus, transitions from each PDP can be forward or backward in time. They are determined by PDPs similar to a current PDP, PDPs similar to natural predecessor of the current PDP, and PDPs similar to natural successor of the current PDP.

To improve connectivity and responsiveness of the graph structure, less desirable transitions may also be added from dominant poses that fall outside of the master pose comparison cost value. In addition to the target pose, each transition may contain associated metadata such as, but not limited to, Root motion (that is, offset of Root transform over time), tags or precisely timed event data such as metadata, and float curves defining volume of speech per frame, or other associated metadata.

It should be appreciated that the process of grouping of dominant poses can be harnessed to produce smaller datasets for resource constrained platforms, such as mobile applications. Larger master pose groups or nodes can be achieved by increasing the similarity threshold, yielding a fewer number of master poses and therefore a smaller graph. In some embodiments, given that dominant poses within a master node are interchangeable to some degree, less important dominant poses can also be dropped to trade quality for reduced memory usage. Furthermore, in some embodiments, grouping could be applied dynamically at runtime as a means of optimizing the graph structure search.

Stated differently, since the dominant poses are grouped based on their transition or comparison cost values, a modulation of a predefined, yet customizable, cost threshold or cutoff affects the number of master poses. The lower the cost threshold, the higher the number of master poses in a graph structure. The higher the cost threshold, the fewer the number of master poses in a graph structure. As discussed earlier, to compare PDP ‘A’ to PDP ‘B’, a set of nodes (that can be joints or a point cloud skinned to joints) are used. The average location of the set of nodes per frame is center of mass. A projection of the center of mass downwards is referred to as the ‘Root’ joint transform. In order to compare PDP ‘A’ to PDP ‘B’, a velocity of each point of the point cloud is measured in the coordinate frame of their respective “root” joints, over time. Over the same time period, a distance between respective points of A and B is also measured (the “distance to cover”). This distance to cover (for interpolation) is divided by the velocity to determine the comparison cost value. It should be appreciated that other functions may be used to determine the comparison cost value using distance to cover data and/or velocity data. In some embodiments, it is assumed that the comparison cost value of 0 is “self” (no distance to cover) and the comparison cost value of 1.0 is “maximum plausible cost” (since there is just enough motion to compensate for offset required to interpolate).

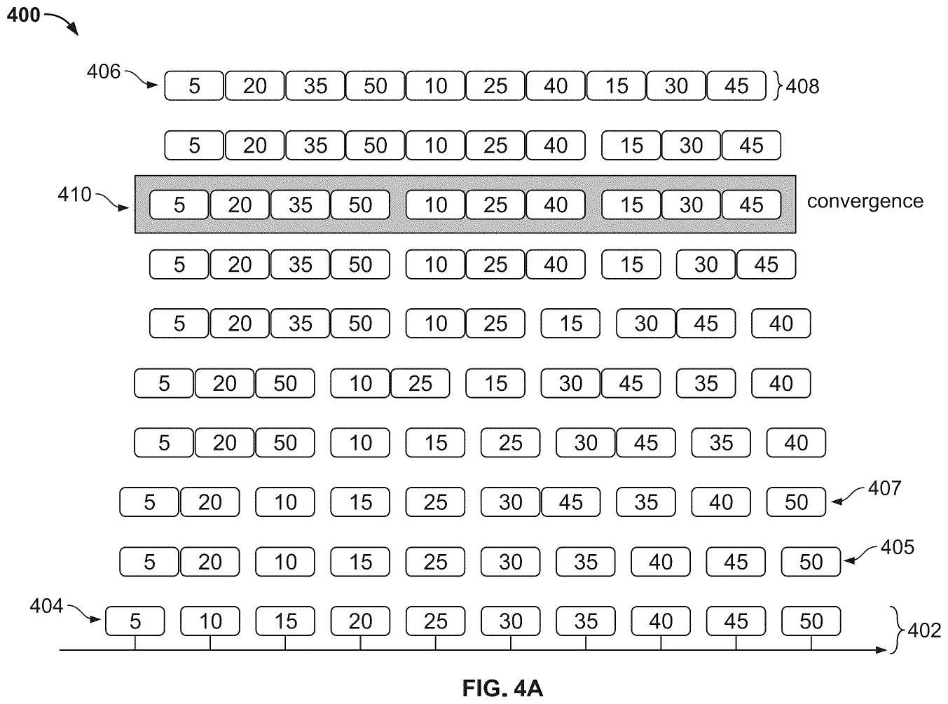

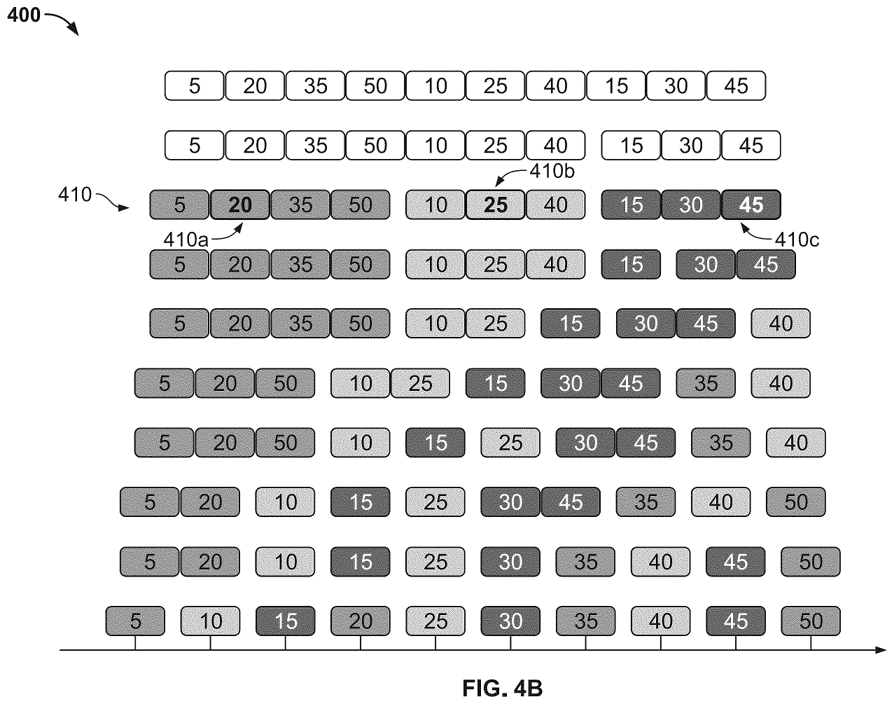

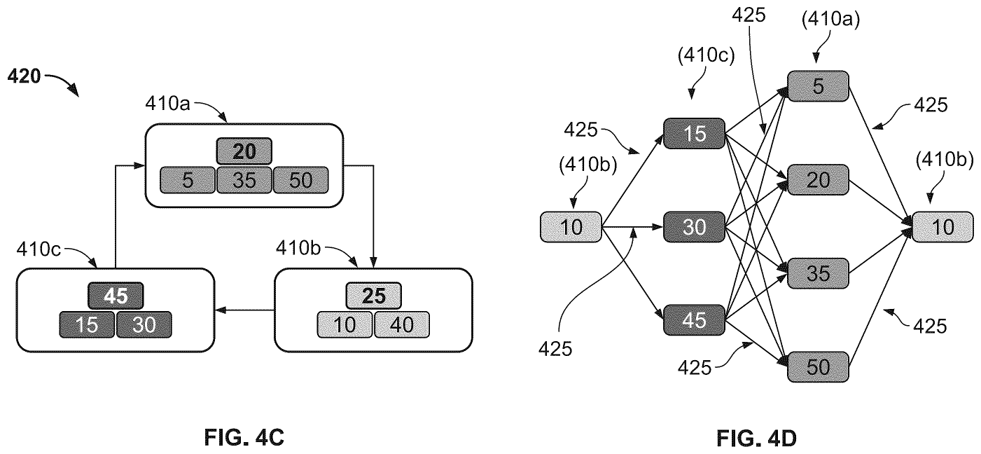

It should be appreciated that in a software application configured to allow an animator to define cost values or thresholds that govern the grouping of dominant poses, in one embodiment, a graphical user interface is generated and configured to receive a cost value that drives the number of master poses in a graph structure. In accordance with some embodiments, any value can be used as a cost threshold. Thus, in some embodiments, if a comparison of PDPs ‘A’ and ‘B’ meets a user defined cost threshold, the two PDPs are considered “successfully similar” or “sufficiently similar” for a transition to be allowed. Also, in some embodiments, if a comparison of PDPs ‘A’ and ‘B’ meets the user defined cost threshold, then the PDPs qualify to be part of (or constitute) a convergence set (described with reference to FIGS. 4A and 4B),—that is, the PDPs are “successfully similar” or “sufficiently similar” to constitute a convergence set. Thus, two PDPs being “successfully similar” or “sufficiently similar” mean that the two PDPs meet a user defined cost threshold.

In one embodiment, multiple cost values may be used to define the dominant and master layers. For example, as shown in FIG. 4A, the set of dominant poses 402 may be grouped or collapsed step-by-step to conceptually represent an HRM (hierarchical reduction matrix) or pyramid structure 400, with cost threshold increasing as one goes up the pyramid 400. In embodiments, by storing only the dominant poses or PDPs and performing pre-calculation of this type allows for quick sliding up or down the pyramid 400 and can be mapped to footprint or cycles required. That is, based on the megabytes of footprint available, a state machine can be generated which contains entities of total cost at or below target. This is effective since the high level routes the state machine takes are effectively the same; thus, state machines for high end platforms will contain several times more versatility but effectively arrive to target by very similar sequences to those of mobile builds of much fewer nodes.

The lowest level 404 of the pyramid 400 is comprised of the source dominant poses or PDPs 402 that are all compared and have costs each to each ranging from 0 to infinity. In the first pass, the most similar of the dominant poses or PDPs are chosen to be grouped together in order to generate the next higher level 405. Thereafter, in the subsequent pass, the next most similar of the dominant poses or PDPs are grouped to generate the next higher level 407. This process of grouping similar dominant poses or PDPs is repeated to generate multiple layers of the pyramid 400 to arrive at a convergence level or set 410 having a minimum set of master poses that have maximum effect (that is, a maximum capacity to achieve a goals set for a game character by game logic, and the best quality possible).

As shown, the lowest level 404 of the pyramid 400 is completely flat, with each dominant pose 402 being its own master, and the top level 406 being a full collapse of whole set of dominant poses 402 into a single master pose 408. Thus, the lowest level of the pyramid 400 contains all dominant poses or PDPs 402 and while traversing up the pyramid 400 one PDP is replaced for each level with a pointer until a single PDP and its mirrored counterpart. In embodiments, the number of levels in the pyramid 400 is equal to number of original dominant poses 402. It should be appreciated that, in one embodiment, the present invention is directed to a non-transitory computer readable memory comprising this data structure.

As shown in FIG. 4B, for case of further analyses and understanding, the first master pose 410a, the second master pose 410b and the third master pose 410c, of the convergence level or set 410, are now represented using first, second and third colors, respectively. In each master pose 410a, 410b, 410c either the most influential dominant pose can be chosen, or a weighted average of the component dominant poses may be generated. In embodiments, the most influential pose can be chosen by measuring its cost over all non-deprecated PDPs. Stated differently, the effect is (1-cost), clamped between 0 and 1. Thus, one gets the effect of each PDP over all other PDPs, which can be accumulated or even weighted (having effect of 1.0 over two independent yet identical PDPs should not give 2.0 but 1.0 since those are clamped as identical). As an illustrative example, the former approach is taken (i.e., the most influential dominant pose is chosen) thereby collapsing the timeline to three master poses or PDPs: 20, 25 and 45, as these are the ones that got clumped together with siblings on the lowest levels of the pyramid 400.

Knowing the predecessor and successor dominant poses for each of the three most influential dominant poses 20, 25 and 45, a generalized graph space 420, of FIG. 4C, may be generated. It should be noted that the component dominant poses, in the same master pose, share good quality connections with the same predecessor and successor dominant poses, since that is the necessary condition for them to be grouped in the first place. While the individual dominant poses 402 (FIG. 4A) may still be stored for increased variety, the graph 420 provides an identical solution whether they are used or not, meaning there is predictable and consistent behavior on all level of details (LOD). Leveraging the generalized graph space 420, FIG. 4D shows that a plurality of graph paths 425 can be generated from any master pose node (first master pose 410a, the second master pose 410b or the third master pose 410c) to any other master pose node. For example, as illustrated in FIG. 4D, graph paths 425 are shown beginning from the dominant pose 10 in the master pose node 410b, then to the dominant poses 15, 30 and 45 in the master pose or node 410c, then to the dominant poses 5, 20, 35, 50 in the master pose node 410a to loop back to the dominant pose 10 in the master pose node 410b. Thus, the generalized graph space 420 can be resolved on high level or low level, with similar results.

Referring back to FIG. 4C, in some embodiments, a search for paths in the graph space 420 may be conducted in multiple passes. For example, a first pass would consider 25→45→20→25. A second pass may compare possible paths by their minute differences and find the best possible route. The first, second and third master pose nodes 410a, 410b, 410c, respectively, are essentially identical nodes since all are of the same duration and are devoid of identity and meaning. Therefore, it could be just collapsed to a 20→25→45 loop. There may be cases of poses which are extremely similar, and may introduce a threshold of meaningful difference. A first approach is to assign an arbitrary number, such as “collapse everything with similarity cost of <=0.1”, while a second approach is to choose such collapse based on desired number of megabytes of the footprint.

As another example, suppose one starts in PDP 15 and wants to achieve PDP 40. If the resource is plentiful, natural connections of both can be evaluated to find that 15 leads to 20, and 35 leads to 40, and 20 and 35 have a cost of 0.1. So, the route is 15-20-40, or 15-15-35-40. But that would entail checking 4 successors of 15, 4 predecessors of 40, and comparing those 4 and 4. Alternatively, one can query successors of 45 (to which 15 points) and predecessors of 25 (to which 40 points). In this realm, only two queries are performed to get 45-20-25, subsequently replacing 45 with 15 and 25 with 40, meaning 15-20-40. Thus, one ends up with the same result as before, but at much higher speed.

Thus, the graph space 420 (of FIG. 4C) is indicative of a high-level planning using few dominant poses, frames or PDPs of the convergence level or set 410 (FIG. 4A) that can be easily unpacked, as shown in FIG. 4D, to multiple unique components for highest fidelity.

FIG. 7C is a flowchart of a plurality of exemplary steps of a method 700c of grouping the identified dominant poses, frames of PDPs to form one or more master poses, in accordance with some embodiments of the present specification. In various embodiments, the method 700c is implemented by the motion synthesis module 125.

At step 702c, based on the comparison of the dominant poses, frames or PDPs, the module 125 identifies those dominant poses, frames or PDPs that have negligible comparison cost values. The comparison cost values associated with each transition from a dominant pose to every other dominant pose are pre-calculated and stored in the database system 120.

At step 704c, each subset of the dominant poses, frames or PDPs having negligible comparison cost values is grouped into a corresponding master pose node. That is, the dominant poses are grouped into one or more master pose nodes based on their transition cost values.

Touch corner use-case: An illustrative, non-limiting, example is of 3200 frames (having an overall duration of just under 2 minutes) of source mocap data. The source mocap data is indicative of walking and turning, but most importantly contact with world object, such as wall corner.

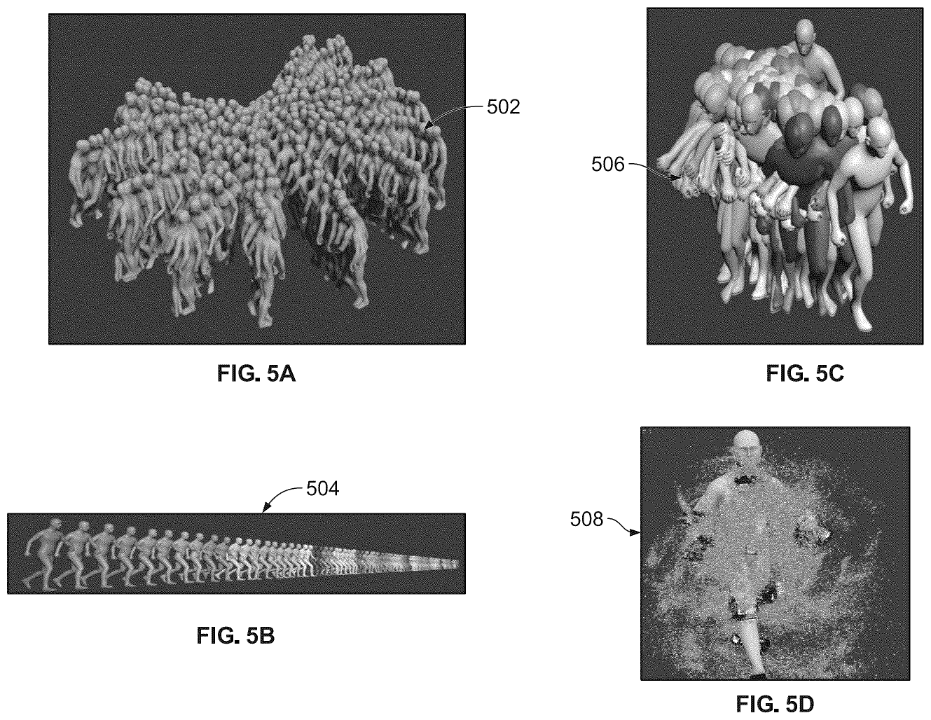

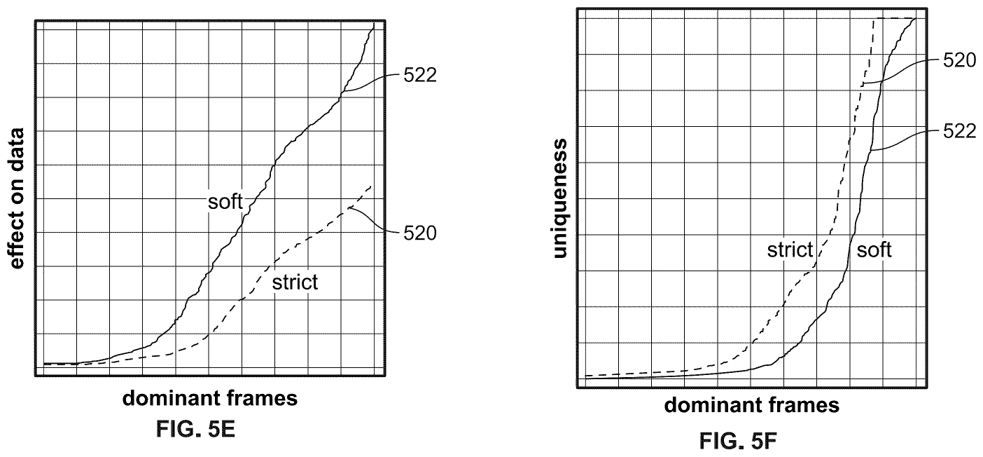

Application of the method of motion segmentation, to the source mocap data, produced 485 dominant poses, frames or PDPs 502, shown in FIG. 5A, with an average duration of 6.6 frames between them. The first 120 and the last 80 frames were deprecated due to T-pose, which could be done manually or automatically. Consequently, the dominant poses, frames or PDPs account for 15.15% of the source mocap data. As known to persons of ordinary skill in the art, in motion capture, takes usually start and end in the actor roughly achieving T-pose (stand straight with arms stretched sideways). This helps spread out the markers. However, the utility of this pose is only relevant for mocap analysis and not for game actions.

FIG. 5B shows a dominant pose at frame 2390 and its 118 closest matches 504 (i.e., the matches with cost <=1.0). Stated differently, FIG. 5B shows PDPs found in the data set but sorted by increasing cost to PDP at frame 2390 (the cost increasing from left to right with the rightmost ones closer to cost of 1.0). Consequently, FIG. 5C shows the direct and natural successors 506, of the 118 matches 504 that are available from the dominant pose at frame 2390. Referring now to FIG. 5D, if, all possible predecessors (Ins) and successors (Outs) of a pose are represented as point cloud using just one minute of mocap data, the result is a field 508 of possible pasts and futures, rated by their likeliness. This shows a portion of “complete” graph structure achievable from the current sample (any PDP is basically a sample of the “complete” graph structure). At this stage, visuals become quite complicated because projection is not just being done in space, but also in time.

FIG. 5E shows how all dominant poses have an effect on the entirety of the source mocap data. If any frame or PDP is taken and its cost is graphed over all data, the graph will show spikes at frames very different from it, and low values at similar frames. This implies that any change introduced to the PDP should affect those low-cost portions of the data as well, since they are so similar to PDP in question. Effectively, it can be reasoned that the whole of the data could be described with a number of non-overlapping samples (PDPs). In turn, it can be reasoned that the more the number of samples used, the higher the fidelity of such description. Consequently, there must be a convergence point where “just enough” PDPs are used to describe the data “as well as possible”.

Referring to FIG. 5E, a first curve 520 corresponding to “strict” is indicative of direct cost comparison, and a second curve 522 corresponding to “soft” is indicative of effect via children proxy. For example, considering PDPs A, B and C-if A to B is 50% and B to C is 50%, it can be assumed that A to Cis 25%. That is, say the effect of A on B or B on A is (1-cost [A, B]), clamped between 0 and 1. Then, if A has the effect of 0.5 on B, and B has effect of 0.5 on C, A's effect on C can be estimated as 0.5\hat{ }2=0.25. However, imagine that directly measured cost [A, C] is 1.0, thus direct effect of A on C seems to be 0. So, “strict” effect is measured directly and is 0. “Soft” by-proxy effect is measured indirectly and is 0.25.

FIG. 5F shows the uniqueness of each dominant pose or PDP over the entirety of the source mocap data. It should be appreciated that the purpose of FIGS. 5E and 5F is to show that the distribution of cost of PDPs in the mocap data is not linear; basically, some PDPs are more mundane/have many similarities, and some are quite unique. This is the foundation for looking into calculating the “effectiveness” of PDPs to understand how their number can be minimized.

Referring now to FIG. 5F, again, the first curve 520 corresponding to “strict” is indicative of direct cost comparison, and a second curve 522 corresponding to “soft” is indicative of effect via children proxy. The most unique dominant poses or PDPs (i.e., about 15% of the source mocap data), if not discarded, will need to be stored but, perhaps, in a lossy way since they are rarely met in the source mocap data. However, half of them are mirrored (if a symmetrical character, for example, a character having no case of “weapon in left hand” or “limping on right foot” is taken, the data can be mirrored and similarities can be easily found between some mirrored and unmirrored PDPs; for example, every left step has similarity to every right step, mirrored), so the number for this example is actually about 140 dominant poses. The least unique ones (about 65% of the source mocap data) should be stored at full quality; however, their number will be low, since each of them is repeated at least 10 times.

In some embodiments, a minimum set of dominant poses can be determined that describe the whole source mocap data. For this example, it is either 286 (“strict”) or 198 (“soft”).

Thus, for the current example, 3200×2=6400 frames of source mocap data is represented by 485 dominant poses and further by 198 minimal master poses or PDPs, representing 3.5 minutes of source mocap data with 6.5 seconds worth of data; and most of these poses are unique, meaning 85% of the data is represented with 30% of the poses. It should be noted that the frame count is initially doubled because the character used in the particular data set is symmetrical allowing for all data to be mirrored. Therefore, the system is capable of storing a one-foot forward step instead of a discrete right foot forward step and left foot forward step.

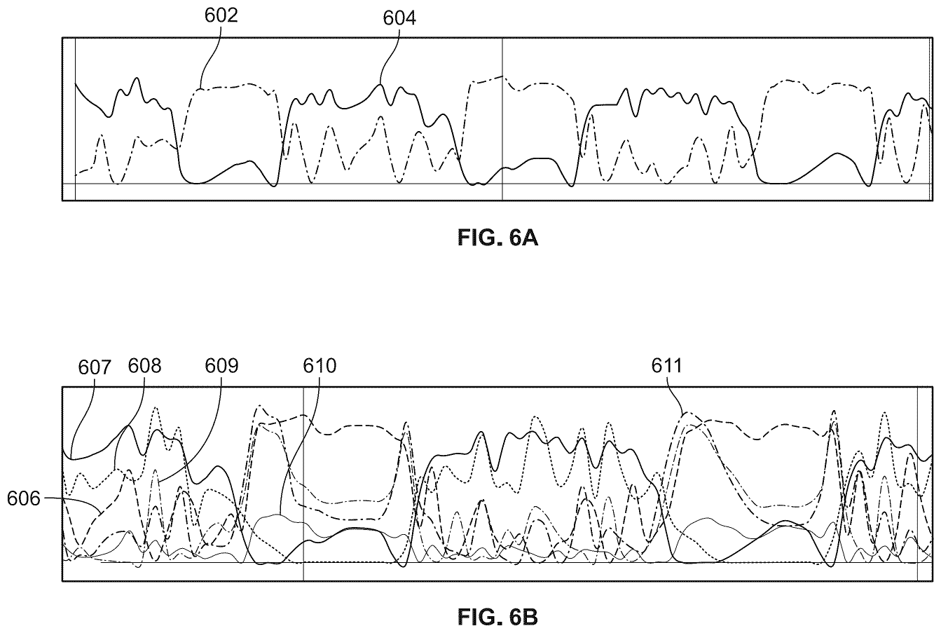

As another illustrative example, FIG. 6A illustrates a visualization of the effect of two master poses or PDPs: a first master pose 602 and a second master pose 604 over timeline. It can be inferred, therefore, that all “original” PDPs in a sequence could be replaced with pointers to this small subset. As yet another illustrative example, FIG. 6B illustrates a visualization of effect of six master poses or PDPs: a first master pose 606, a second master pose 607, a third master pose 608, a fourth master pose 609, a fifth master pose 610 and a sixth master pose 611 over timeline. It can be inferred, therefore, that portions of data would be replicated with more fidelity (more accurately) if six master poses or PDPs are used instead of two.

In embodiments, to generate the graph structure, the motion synthesis module 125 is further configured to add a plurality of transitions based on successive dominant poses, frames or PDPs present in each master pose node or group such that each of the plurality of transitions includes Root transform offset and a duration. Also, a further plurality of transitions may be added based on similarity and connectivity requirements. For maximum flexibility, in some embodiments, the graph structure needs to be strongly connected.

Thus, say there is a pose, PDP 100, that is achieved quite often. Unfortunately, little data was captured for it, and it can only lead to pose 101 with cost under 0. So one is often required to force it to pose 200 and pose 300, with costs of 2.0 and 3.0 respectively. By “forced”, it is meant that from a state of having pose 100 we are often required (by user or AI) to perform actions uniquely associated with pose 200 or 300—perhaps, those are roll left and roll right. Every time a connection is performed with quality cost of over 1.0, forced by other factors, we can output it to the list of forced bad connections. Such list then can be exposed to animators as examples of motions which need a more artistic “bridge”, either to be factored into the next mocap session (make actor do many sideways rolls) or created manually, for example.

### Adding New Content

Any new content or mocap data, that is added to the database system 120, goes through the same process of graph structure construction, as described above in this specification, thereby allowing expansion of an existing list of master poses and their connections. Thus, when new content or mocap data is added, the motion synthesis module 125 is configured to determine the center of mass (COM) and Root per frame, measure the work done, use that to assign dominant poses or PDPs, compare new PDPs with existing ones, output/update PDPs, their respective connectivity and costs per connection, generate the hierarchal reduction matrix (HRM) or pyramid and determine the convergence level of the HRM.

It should be appreciated that, since the systems and methods of the present specification do not store a blend tree but sparse data points with their capacity of linking together over time, there is a drastic decrease in the footprint. Further, the master pose nodes can have several LOD's or basically be nested. As a result, a varying number of master poses can be used across different platforms, with the difference being not the full range of character motions, not the quality of them, but the versatility allowed. Thus, there would be a core set of master poses dealing with locomotion, and branching from it, a number of interaction sets, all connected through some master pose.

### Data Stored

In embodiments, for each of the resulting set of master poses or PDPs, at least the following data is stored in the database system 120: a) velocity data indicative of an average displacement of body parts over a past frame using point cloud, b) acceleration data, c) force invested or spent (average force acting on each unit of body; actual location compared to predicted one based on previous location, velocity, gravity), d) location and orientation of center of mass (COM) of a body pose, c) location and orientation of Root, f) any tags for events (single frame) or states (duration), including “deprecated” tags which exclude portions of data from calculation, and any tags game logic may query, g) current transforms and velocities, h) index of PDP, i) address of PDP—that is, file and frame, j) list of similarity costs to all other PDPs, k) a list of dominant poses or PDPs affected (that is, PDPs similar to current one (cost under 1.0)), including weights (costs, or possibly soft/strict “effect” described earlier in this specification), l) reference/pointer to closest similar PDP with respective cost, m) original predecessor and successor PDP—that is, a list of incoming master poses or PDPs (predecessors on a timeline) with costs of blending as well as a list of outgoing master poses or PDPs (successors on the timeline) with costs of blending, n) number of possible predecessors and successors in current data with cost <=1.0, as well as offsets to each in space and time, o) any user defined tag (such as, for example, “sneeze”), p) any information related to collision object transform relative to Root, q) any information related to body parts colliding, and r) any information on context outside that derived from anatomical pose, such as amplitude of speech etc. It should be appreciated that, in one embodiment, the present invention is directed to a non-transitory computer readable memory comprising this data structure.

In some embodiments, at least following data is also stored in the database system 120 for each dominant pose: a) address in animation or mocap data file and specific frame, b) pointers to other nodes which a current one may be replaced with in different levels of master nodes, and cost of such replacement, c) any set of tags (for events, states), d) linear velocity and position, and d) successor' and predecessor data such as, but not limited to: i) index of other node, ii) connection quality cost, iii) Root linear and angular offset transform, iv) capacity for translation scale (footstep scaling-a mechanics which scales horizontal offset over time for Root, pelvis and foot IK nodes, preserving upper body. As a result, the character seems to cover more or less distance using the same core animation.), v) connection length in frames, vi) capacity for time scale (time warp—that is, fluctuation of the motion playback speed. This is performed based on the amount of velocity per frame, meaning fast motions get less warping and slow motions have higher capacity to be sped up or slowed down with minimal artistic error), vii) connectivity to self (i.e., capacity to loop), and connectivity to saturate the graph structure (i.e., capacity to reach each other dominant pose). It should be appreciated that, in one embodiment, the present invention is directed to a non-transitory computer readable memory comprising this data structure.

### Characteristics and Benefits of a Graph Structure

Generation of a graph structure, of the present specification, enables the source motion data to be viewed as a 4D (four dimensional) object which is composed of a plurality of master pose nodes and their influences over the source motion data. Transitions from any dominant pose to any other dominant pose are also included in the graph. The graph structure can be represented as a procedurally generated nested state machine generated for each required start and target state.

The graph structure has a plurality of characteristics. For example, all of the dominant poses required are art friendly. The artists can think of it as a pose library generated for them. Unlike the classic pose library, this one is based on data connectivity, and is much denser, allowing multiple branch points per second. This supports a realistic yet controlled approach to the sculpting of any motion.

Again, for most solutions, multiple possible paths can be found and their costs compared, wherein the comparison can be based on specific needs at the time of query, and can be distributed over ‘N’ frames. This allows game logic to not only set desired start and goal states but introduce any optional number of states to reach in the process. In turn, this means fast reaction time and good responsiveness yet high realism of an AI-driven animation system.

Additionally, any part of the animation data (PDPs, in relation to capacity of the character to achieve desired motions/actions) is now easy to analyze for its importance. There is also a direct byproduct as knowledge of areas where the data is too sparse (add more) or too dense (deprecate). Stated differently, this approach allows for an analysis of cases where the connectivity is too low or too high—providing an insight of which motions to add to the system. For example, there is no need to “guess” the number of special idles to generate. Since any playback is being tracked during any game session on developer and quality assurance side at least, a good insight can be had into which PDPs are achieved most frequently, and which are never used.

The graph structure has a plurality of benefits such as, but not limited to: a) enabling fully automated transitions, b) reducing redundancy in animation data, c) representing motion data at a higher level of abstraction, allowing groups of poses to be treated as a whole for editing or stylization, d) offering potential for (lossy) data compression without limiting possible motion, c) allowing offline data analysis to identify bad transitions or areas where further animation data is needed, f) enabling improved responsiveness compared to conventional motion graphs, g) providing more predictable results when adding or removing animation data compared to the conventional motion matching technique, and h) providing ability to support complex motion constraints.

The system of the present specification enables a plurality of options such as, for example: offline/runtime motion stylization and removal of respective data from the footprint, a population of possible goal-to-reach space for each pose, an improvement of “immediate impossible blend to” solution, a packing required pose data to indexed list for cheap data transfer, pose and time warping for improved quality and timing of targeted events, solving against unusual constraints, constraints over time (full body to speech, dance to location, etc.), quality of motion matching, and control of blend trees.

### A Method of Generating a Graph Structure

FIG. 7D is a flowchart of a plurality of exemplary steps of a method 700 of generating a graph structure configured to enable controlled character motion synthesis, in accordance with some embodiments of the present specification. In various embodiments, the method 700d is implemented by the motion synthesis module 125.

Referring now to FIGS. 1 and 7, at step 702d, acquire and store, in the database system 120, a corpus of source mocap data indicative of a plurality of animation clips where each of the plurality of animation clips is representative of a sequence of poses over time and includes a plurality of frames. Alternatively, or additionally, the database system 120 may store hand-authored or procedurally generated data containing fluid realistic motion.

At step 704d, the module 125 automatically identifies or determines, from the corpus of source mocap data, a subset of artistically relevant dominant poses, frames or PDPs. In some embodiments, the source mocap data is sampled using a measurement of force invested or spent (that is, work done). The poses or frames corresponding to values of peaks and valleys of a force or work done curve are identified as dominant poses, frames or PDPs.

At step 706d, the module 125 calculates an associated uniform center of mass (COM) and Root for each of the identified dominant poses, frames or PDPs. Root is the space in which animations are played, and also serves as a generalized idea of character placement in the game. COM is useful for many reasons, such as, for example, balance restoration in case of runtime pose changes, lazy pose comparison, physics/ragdoll factor, and any other reason to use COM in accordance with the present invention.

At step 708d, the module 125 compares each of the identified subset of dominant poses, frames or PDPs against the other or remaining dominant poses, frames or PDPs (within the identified subset of dominant poses) using a similarity metric calculated over a fixed time window centered at each pose or frame. In some embodiments, the similarity metric is a comparison cost value determined by dividing the distance between some node of PDP ‘A’ and the same node of PDP ‘B’, by an average velocity of the two PDPs. Thereafter, taking an average or median result of all nodes combined. In some embodiments, the similarity metric is used to define, establish or otherwise form a convergence set of PDPs.

At step 710d, the module 125 groups the dominant poses, with negligible transition cost values (indicative of similar motion over the time window), to form one or more master pose nodes in the graph structure. Thus, the graph structure encapsulates a plurality of master pose nodes where each of the plurality of master pose nodes includes a group of constituent dominant poses indicative of a similar motion or animation.

At step 712d, the module 125 adds a plurality of transitions based on successive dominant poses, frames or PDPs present in each master pose node or group such that each of the plurality of transitions includes Root transform offset and a duration. A further plurality of transitions is added based on similarity and connectivity requirements. In embodiments, the term ‘transition’ refers to the allowed pairs of PDPs to select later in an animation sequence. For example, suppose there are PDPs ‘A’, ‘B’ and ‘K’. In accordance with some embodiments, if a user-defined cost threshold is 0.5 then PDPs with comparison cost values under 0.5 are considered ‘sufficiently or successfully similar’ and allowed for transition. Now, if the comparison cost (B, K)=0.4, then the transition from PDP ‘A’ (that is a native predecessor of PDP ‘B’) to PDP ‘K’ is allowed. Stated differently, PDPs need to be ‘sufficiently or successfully similar’ in order to qualify as potential transition pairs, in which case they are then allowed to be successive.

In embodiments, the module 125 generates motion at runtime by applying one or more dominant poses from the one or more master nodes and by applying one or more transitions that match a plurality of control parameters, wherein the plurality of control parameters describe a desired motion of a character in a multi-player online game. Thus, an online multi-player gaming system is configured to feed on pre-processed data, indicative of a graph structure, that is leveraged at runtime to find best possible motion to play or synthesize for any set of animation goals. The generated runtime motion is mandatorily deterministic in case of user-side or player-side pose construction.

It should be appreciated that the approach of the graph structure can be used for other applications as well such as, but not limited to, cinematics, blocking in Autodesk Maya software, and to generate training data for machine learning. The following are illustrative non-limiting examples of the use of the approach of the graph structure in other applications:

In a first example, the approach of the graph structure may be used to block in motion over time (in cinematics or a regular pipeline). If it is assumed that an animator has a timeline between frames 0 and 100, at frame 0, they may choose one of a plurality of PDPs and place it in a certain world location. They may then choose any preferred PDP for frame 100, and any preferred location. They may then repeat the process inside the timeline as well. The approach of the graph structure, of the present specification, can then be used to generate any number of possible PDP sequences to fit the timeline, world transforms, and desired PDPs blocked in by the animator, thereby, creating a number of possible animation sequences for the character to achieve all those poses sequentially.

In a second example, a semi-procedural graph structure approach may be used. For example, an artist may specify some start area and target area, and one by one the approach of the graph structure, of the present specification, can be used to choose a random location in the start area and find means to navigate to the random location in the target area. This is repeated for multiple characters, keeping in mind spatial transforms of “already solved” ones to avoid collision. Such an approach can service quick prototyping (or high-quality simulation) of crowds.

Further, machine learning solutions can benefit by learning all transitions allowed (defined by an artist, for example with cost <0.1), to then generate new transitions between poses not in the learning set.

The above examples are merely illustrative of the many applications of the systems and methods of the present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A computer-implemented method of generating a graph structure configured to enable a synthesis of character motion in a multi-player online video game, the method comprising:
receiving motion capture data;
identifying a plurality of dominant poses from motion capture data;
comparing each dominant pose of the plurality of dominant poses against each remaining ones of the plurality of dominant poses;
grouping the dominant poses to form one or more master pose nodes, wherein the dominant poses in each of the one or more master pose nodes are indicative of similar motion over a time window; and
adding a plurality of transitions based on successive dominant poses present in each master pose node, wherein each of the plurality of transitions represents pairs of dominant poses that are sufficiently similar for selection in an animation sequence.

2. The computer-implemented method of claim 1, wherein said identifying the plurality of dominant poses is achieved by sampling the motion capture data to determine poses associated with different positions along a force curve and wherein those poses corresponding to maximum and minimum values of the force curve are identified as said dominant poses.

3. The computer-implemented method of claim 1, wherein the comparison is based on a similarity metric calculated over a fixed time window centered at each dominant pose.

4. The computer-implemented method of claim 3, wherein the similarity metric is a comparison cost value.

5. The computer-implemented method of claim 1, wherein each of the plurality of transitions comprises a Root transform offset and a duration.

6. The computer-implemented method of claim 1, wherein the motion capture data can be derived from the plurality of dominant poses by extrapolating a force curve across the plurality of dominant poses.

7. The computer-implemented method of claim 1, further comprising generating motion in the multi-player online video game at runtime by applying one or more of the plurality of dominant poses from the one or more master nodes and by applying one or more of the plurality of transitions that match a plurality of control parameters, wherein the plurality of control parameters define a desired motion of a character in the multi-player online video game.

8. The computer-implemented method of claim 1, further comprising storing data for each of the one or more master pose nodes, wherein the data comprises at least one of dominant poses, weights associated with each of the dominant poses, poses preceding said each of the one or more master pose nodes, a cost of blending said preceding poses, poses succeeding each of the one or more master pose nodes, costs of blending said succeeding poses, and one or more metadata.

9. A system of generating a graph structure configured to enable a synthesis of character motion in a multi-player online video game, the system comprising:
at least one game server in communication with a plurality of player client devices, wherein the at least one game server has a non-volatile memory for storing a plurality of programmatic code which, when executed, cause a processor to:
receive motion capture data;
identify a plurality of dominant poses from the motion capture data;
compare each dominant pose of the plurality of dominant poses against each remaining ones of the plurality of dominant poses;
group the dominant poses to form one or more master pose nodes, wherein the dominant poses in each of the one or more master pose nodes are indicative of similar motion over a time window; and
add a plurality of transitions based on successive dominant poses present in each master pose node, wherein each of the plurality of transitions represents pairs of dominant poses that are sufficiently similar for selection in an animation sequence.

10. The system of claim 9, wherein said identifying the plurality of dominant poses is achieved by sampling the motion capture data to determine poses associated with different positions along a force curve and wherein those poses corresponding to maximum and minimum values of the force curve are identified as said dominant poses.

11. The system of claim 9, wherein the comparison is based on a similarity metric calculated over a fixed time window centered at each dominant pose.

12. The system of claim 11, wherein the similarity metric is a comparison cost value.

13. The system of claim 9, wherein each of the plurality of transitions comprises Root transform offset and a duration.

14. The system of claim 9, wherein the motion capture data can be derived from the plurality of dominant poses by extrapolating a force curve across the plurality of dominant poses.

15. The system of claim 9, wherein the plurality of programmatic code, when executed, further causes the processor to generate motion in the multi-layer online video game at runtime by applying one or more of the plurality of dominant poses from the one or more master nodes and by applying one or more of the plurality of transitions that match a plurality of control parameters, wherein the plurality of control parameters define a desired motion of a character in the multi-player online video game.

16. The system of claim 9, wherein the plurality of programmatic code, when executed, further causes the processor to store data for each of the one or more master pose nodes, wherein the data comprises at least one of dominant poses, weights associated with each of the dominant poses, poses preceding said each of the one or more master pose nodes, a cost of blending said preceding poses, poses succeeding each of the one or more master pose nodes, costs of blending said succeeding poses, and one or more metadata.

17. A method of generating a graph structure, comprising:
receiving motion capture data;
identifying a plurality of dominant poses from the motion capture data;
comparing each dominant pose of the plurality of dominant poses against each remaining ones of the plurality of dominant poses, wherein the comparison is based on a similarity metric calculated over a fixed time window centered at each dominant pose;
grouping the dominant poses to form one or more master pose nodes, wherein the grouped dominant poses have transition cost values below a predefined threshold; and
adding a plurality of transitions based on successive dominant poses present in each master pose node, wherein each of the plurality of transitions represents pairs of dominant poses that are sufficiently similar for selection in an animation sequence.

18. The method of claim 17, wherein said identifying the plurality of dominant poses is achieved by sampling the motion capture data to determine poses associated with different positions along a force curve and wherein those poses corresponding to maximum and minimum values of the force curve are identified as said dominant poses.

19. The method of claim 17, wherein each of the plurality of transitions comprises Root transform offset and a duration.

20. The method of claim 17, wherein the motion capture data can be derived from the plurality of dominant poses by extrapolating a force curve across the plurality of dominant poses.

21. The method of claim 17, further comprising: generating motion in the multi-player online video game at runtime by applying one or more of the plurality of dominant poses from the one or more master nodes and by applying one or more of the plurality of transitions that match a plurality of control parameters, wherein the plurality of control parameters define a desired motion of a character in the multi-player online video game.

22. The method of claim 17, further comprising storing data for each of the one or more master pose nodes, wherein the data comprises at least one of dominant poses, weights associated with each of the dominant poses, poses preceding said each of the one or more master pose nodes, a cost of blending said preceding poses, poses succeeding each of the one or more master pose nodes, costs of blending said succeeding poses, and one or more metadata.
